(19) United States
(12) Patent Application Publication
(10) Pub. No.: US 2005/0091325 A1
(43) Pub. Date: Apr. 28, 2005

(54) Information providing system

(76) Inventors: Kenji Kuwana, Chiba (JP); Takezo Fujishige, Kanagawa (JP); Kiyoshi Kasatani, Kanagawa (JP); Toshiyuki Tezuka, Tokyo (JP)

Correspondence Address: MORRISON & FOERSTER LLP, 1650 TYSONS BOULEVARD, SUITE 300, MCLEAN, VA, 22102, US

(21) Appl. No.: 10/941,079

(22) Filed: Sep. 15, 2004

(30) Foreign Application Priority Data
Sep. 18, 2003 (JP) 2003-326028
Aug. 26, 2004 (JP) 2004-247064

(51) Int. Cl. G06F 15/16

(52) U.S. Cl. 709/206

(57) ABSTRACT

An information providing system is disclosed that includes: plural multifunctional information stations having at least printing, facsimile, and e-mailing functions; and a center server connected to the multifunctional information stations via a network. The center server receives applications, issues documents, and distributes information via the multifunctional information stations. A user can file an application and have a document issued using the multifunctional information station disposed in a convenience store.

### BACKGROUND OF THE INVENTION

1. hField of the Invention

The present invention generally relates to an information providing system, and more particularly, to an information providing system in which, through multifunctional information stations disposed in convenience stores, people can submit applications to a local government and the local government can issue documents or distribute information, for example.

2. Description of the Related Art

Conventionally, people need to visit the main office or the satellite offices of the local government when they need to have various documents, such as a domicile registration paper, issued. People generally need to go to a window, fill in a form, and pay an issuance fee.

When the local government distributes information to people, the local government prints paper media, such as a public information paper, for distribution. Alternatively, the local government prepares a paper circular and has community associations circulate copies of the circular.

Likewise, people need to visit in person a police station.

As described above, people conventionally need to visit the counter of the local government office in person. People need to spend time and effort for transportation, and sometimes need to wait for a long time for the document to be issued. The window is open during a limited time, so people may need to adjust their schedule.

If a circular is circulated by a community association, the person in charge of the community association needs to spend time for distributing the circular. If the circular distribution list is not exhaustive, the people who are not on the circular distribution list may lose the chance to be informed. A circular may take time to be circulated, and its information may stagnate.

### SUMMARY OF THE INVENTION

Accordingly, it is a general object of the present invention to provide a novel and useful information providing system in which at least one of the above problems is eliminated.

Another and more specific object of the present invention is to provide an information providing system in which, through multifunctional information stations disposed in convenience stores, people can easily submit applications to a local government and the local government can issue documents or distribute information, for example.

To achieve at least one of the above objects, according to the present invention, an information providing system includes: a plurality of multifunctional information stations having at least printing, facsimile, and e-mailing functions; and a center server connected to the multifunctional information stations via a network, wherein the center server receives applications, issues documents, and distributes information via the plurality of multifunctional information stations.

The user can file an application and have a document issued using the multifunctional information station disposed in a convenience store, for example. As a result, the user does not need to visit the local government, for example, in person, and does not need to wait for the document to be issued. The user can receive distributed information from the local government, for example, through facsimile, e-mail, or as printed material. The organization that manages the information providing system can reduce overhead considerably. The use of such an information providing system reduces consumption of natural resources such as paper.

Other objects, features, and advantages of the present invention will become more apparent from the following detailed description when read in conjunction with the accompanying drawings.

### BRIEF DESCRIPTION OF THE DRAWINGS

FIG. 1 is a network diagram showing an information providing system according to an embodiment;

FIG. 2 is a block diagram showing the functions of a center server according to an embodiment;

FIG. 3 is a diagram showing the fields of a user information database according to an embodiment;

FIG. 4 is a diagram showing the fields of an administrator information database according to an embodiment;

FIG. 5 is a diagram showing the fields of a bank transmission database according to an embodiment;

FIG. 6 is a diagram showing the fields of a store information database according to an embodiment;

FIG. 7 is a hardware diagram showing a multifunctional information station according to an embodiment;

FIG. 8 is a perspective view showing the appearance of the multifunctional information station of FIG. 7;

FIG. 9 is a partial view showing the appearance of the operations unit of the multifunctional information station of FIG. 7;

FIG. 10 is a block diagram showing the functions of the multifunctional information station of FIG. 7;

FIG. 11 is a flowchart showing the operation of a user/fingerprint registration unit according to an embodiment;

FIG. 12 is an exemplary screen for registering user information, for example, according to an embodiment;

FIG. 13 is an exemplary screen for adding and deleting user information, for example, according to an embodiment;

FIG. 14 is a flowchart for explaining processing of applications, requests, and inquiries according to an embodiment;

FIG. 15 is a flowchart for explaining the distribution of information according to an embodiment;

FIG. 16 is a flowchart for explaining the issuance of documents according to an embodiment; and

FIG. 17 is a flowchart for explaining withdrawal according to an embodiment.

### DETAILED DESCRIPTION OF THE PREFERRED EMBODIMENTS

The preferred embodiments of the present invention are described in detail below with reference to the drawings.

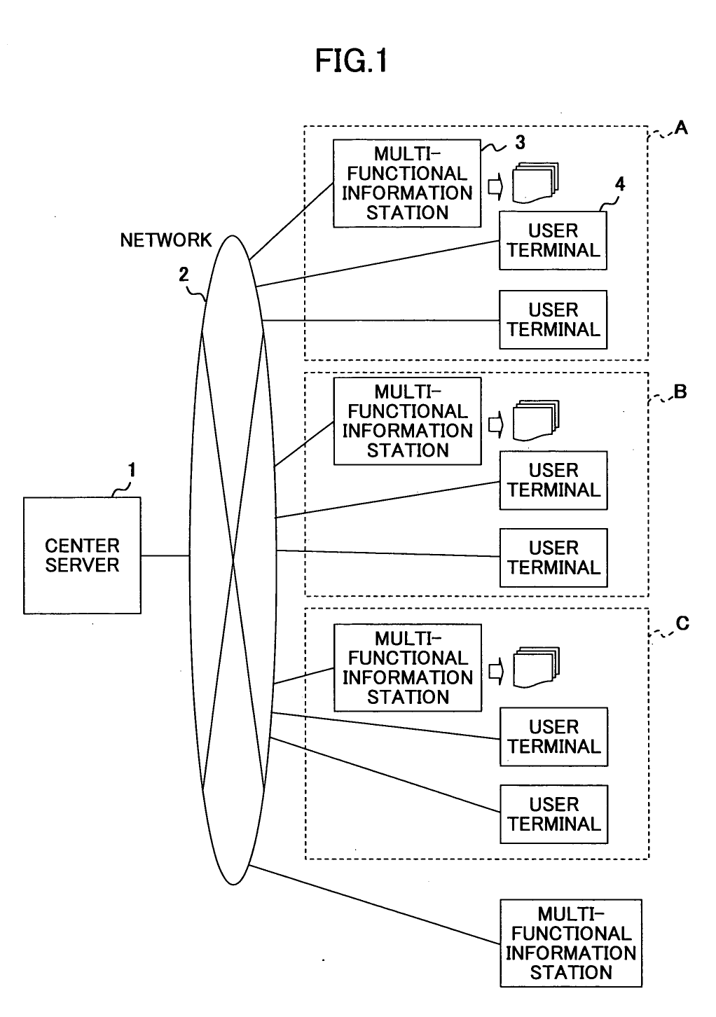

FIG. 1 is a network diagram showing an information providing system according to an embodiment.

As shown in FIG. 1, an information providing system according to an embodiment of the present invention includes the following: a center server 1 managed by the local government; multifunctional information stations 3 disposed in regions A, B, and C, the multifunctional information station 3 having functions such as printing, facsimile, and e-mailing; user terminals 4 disposed in the regions A, B, and C, the user terminal being a personal computer, for example, owned by a user. The center server 1, the multifunctional information stations 3, and the user terminals 4 are connected to each other via a network 2 such as the Internet. There may be a multifunctional information station 3 disposed in a user's premises. A user terminal 4 may be connected to the network 2 via a multifunctional information station 3.

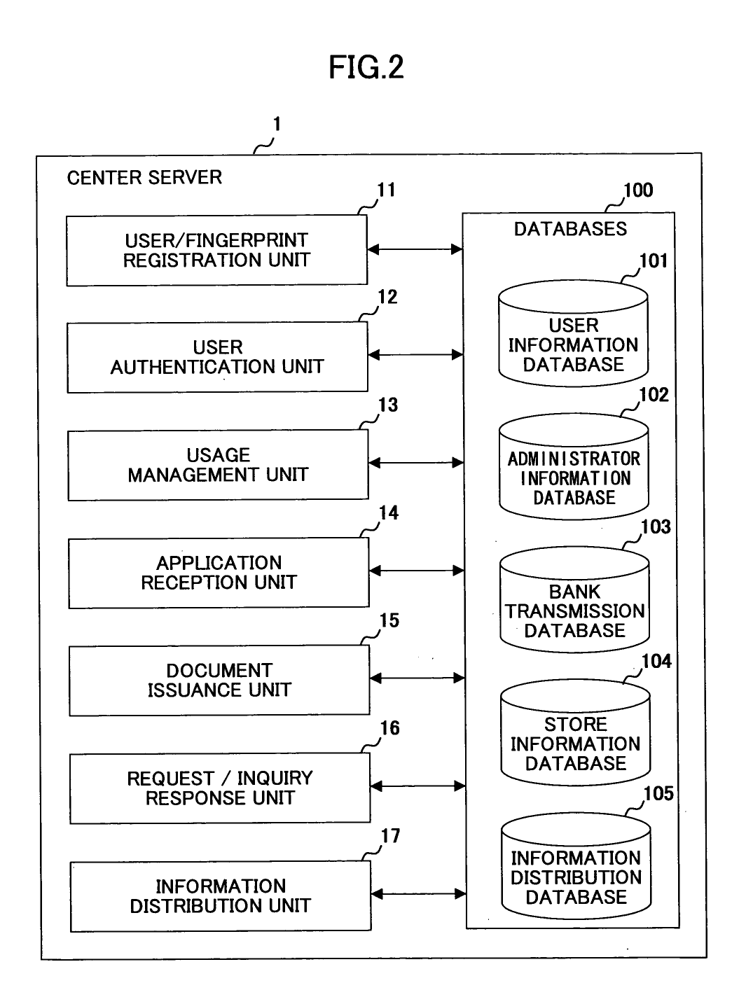

FIG. 2 is a block diagram showing the functions of a center server according to an embodiment. The center server 1 may be provided with the following: a user/fingerprint registration unit 11 that registers user information and the fingerprint of the user in response to a user's operation; a user authentication unit 12 that authenticates a user when the user uses the multifunctional information station 3; and a usage management unit 13 that manages the use state of the multifunctional information station 3 based on images from a monitor camera provided in the convenience store and a use log. The center server 1 further includes the following: an application reception unit 14 that receives various applications in response to a user's operation; a document issuance unit 15 that issues documents using the printing function of the multifunctional information station 3 in accordance with the application of the user; a request/inquiry response unit 16 that responds to a request or an inquiry from the user; and an information distribution unit 17 that distributes information from the local government using the facsimile function, e-mailing function, and printing function, for example, of the multifunctional information station 3.

The center server 1 is further provided with the following databases 100: a user information database 101 that stores user information (including fingerprint information); an administrator information database 102 that stores e-mail addresses, for example, of administrators of the center server 1; and a bank transmission database 103 that stores data related to the fee withdrawal from users' bank accounts. The center server 1 is further provided with the following databases 100: a store information database 104 that stores store information; and an information distribution database 105 that stores information distributed from the local government or other information providers. The databases 100 may be used for processing by the multifunctional information station 3, and may be duplicated in the multifunctional information station 3.

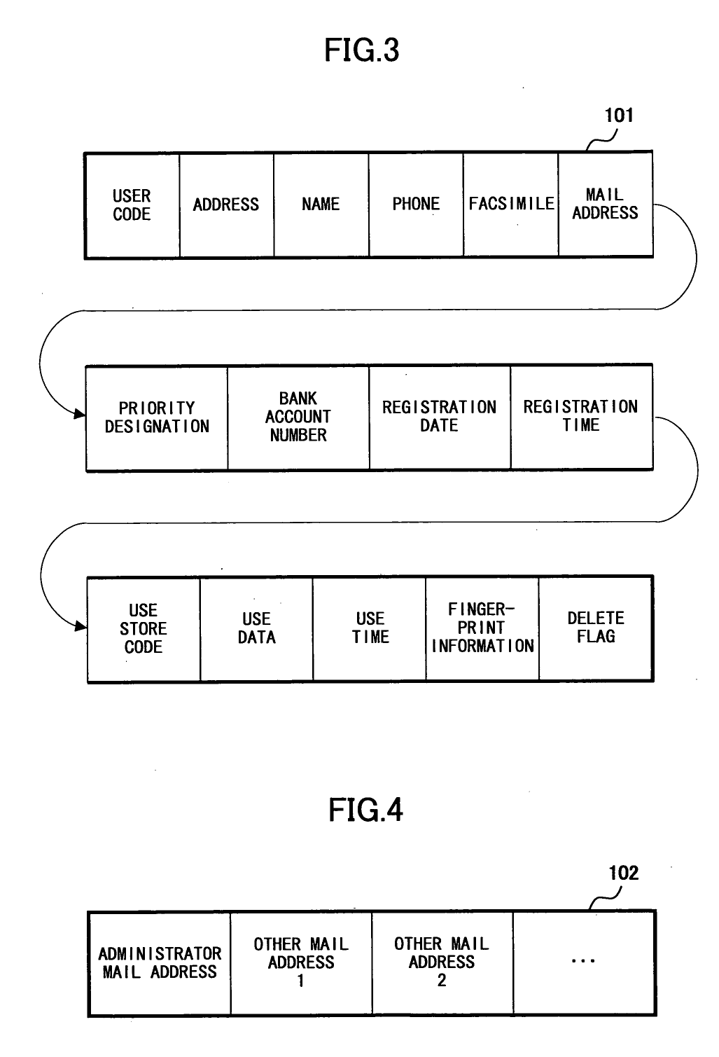

FIG. 3 is a diagram showing the fields of a user information database 101 according to an embodiment. The user information database 101 includes the following fields: a user code, an address, a name, a phone number, a facsimile number, a mail address, a priority designation, a bank account number, a registration date, a registration time, a use store code, a use date, a use time, fingerprint information, and a delete flag, for example.

The “user code” field contains data for identifying each user who uses the information providing system. The “address” field contains data related to the address of the user. The “name” field contains data related to the full name of the user. The “phone” number field contains data related to the phone number of the user. The “facsimile” number field contains data related to the facsimile number of the user. The “mail address” field contains data related to the e-mail address of the user. The “priority designation” field depends on the method in which the user receives distributed information. Specifically, if the information is distributed via facsimile, the priority designation field becomes “1”, and if via e-mail, the priority designation field becomes “2”. If neither the facsimile nor e-mail is used, the priority designation field becomes “0”.

The “bank account number” field contains data related to the bank account number of the user. The “registration data” field and the “registration time” field contain data related date and time, respectively, at which the entry of the user is made or updated. The “use store code” field contains data related to a store or a place at which the user has used the information providing system specifically, it contains data related to the store or the place where the user has registered data in the user information database 101 in order to use the information providing system. If the user uses the information providing system at a different store or place the next time, the “use store code” field is updated by the store code of the different store or place.

The “use date” and “use time” fields contain data related to date and time, respectively, at which the user uses the information providing system. As the user uses the information providing system next time after next time, the use date and use time fields are correspondingly updated until the user's entry in the user information database 101 is deleted.

The “fingerprint information” field contains data related to the fingerprint information of the user. The “delete flag” field contains data indicating whether the entry of the user has been deleted. Specifically, if the entry of the user has been deleted, the delete flag is set to “1”, otherwise “0”. If the entry of the user is deleted, the user cannot use the information providing system any more. The use date and time may be recorded in a log file.

FIG. 4 is a diagram showing the fields of an administrator information database 102 according to an embodiment. The administrator information database 102 includes the following fields: an “administrator mail address” field, an “other mail address 1” field, and an “other mail address 2” field, and so forth. The “administrator mail address” field contains data related to the e-mail address of an administrator who manages the information providing system. The mail addresses of people related to the operation of the information providing system other than the administrator may be contained in the “other mail address 1” field, the “other mail address 2” field, and so forth. The number of fields of the administrator information database may be increased to as many as the number of people related to the operation of the information providing system.

FIG. 5 is a diagram showing the fields of a bank transmission database 103 according to an embodiment. The bank transmission database 103 includes a “user code” field, a “name” field, a “bank account number” field, a “use amount” field, a “flag indicating data transmitted” flag, and a “flag indicating withdrawal processed” flag, for example. The “user code” field contains data for identifying a user. Specifically, as will be appreciated, if a user wishes that the use fee be withdrawn from the bank account, the same “user code” as that of the user information database 101 is set. The “bank account number” field contains data related to the bank account number of the user. Specifically, if the user wishes that the use fee be automatically withdrawn from her bank account, the same bank account number as that of the user information database 101 is set in this field. The “use amount” field contains data related to the use fee that the user pays.

The “flag indicating data transmitted” field contains data indicating whether data to be transmitted to a bank have been transmitted. Specifically, if the data have not been transmitted, the flag field is set to “0”, otherwise “1”. The “flag indicating withdrawal processed” field contains data indicating whether the withdrawal has been processed after the data have been transmitted. Specifically, if the withdrawal has not been processed yet, the flag field is set to “0”, otherwise “1”.

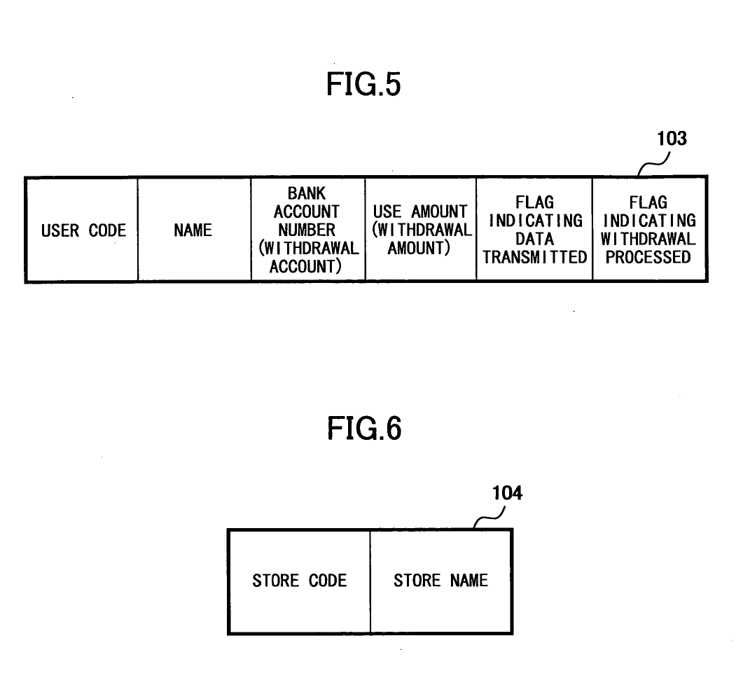

FIG. 6 is a diagram showing the fields of a store information database 104 according to an embodiment. The store information database 104 is provided with a “store code” field and a “store name” field. The “store code” field contains data for identifying a store. The “store name” field contains data related to the name of the store.

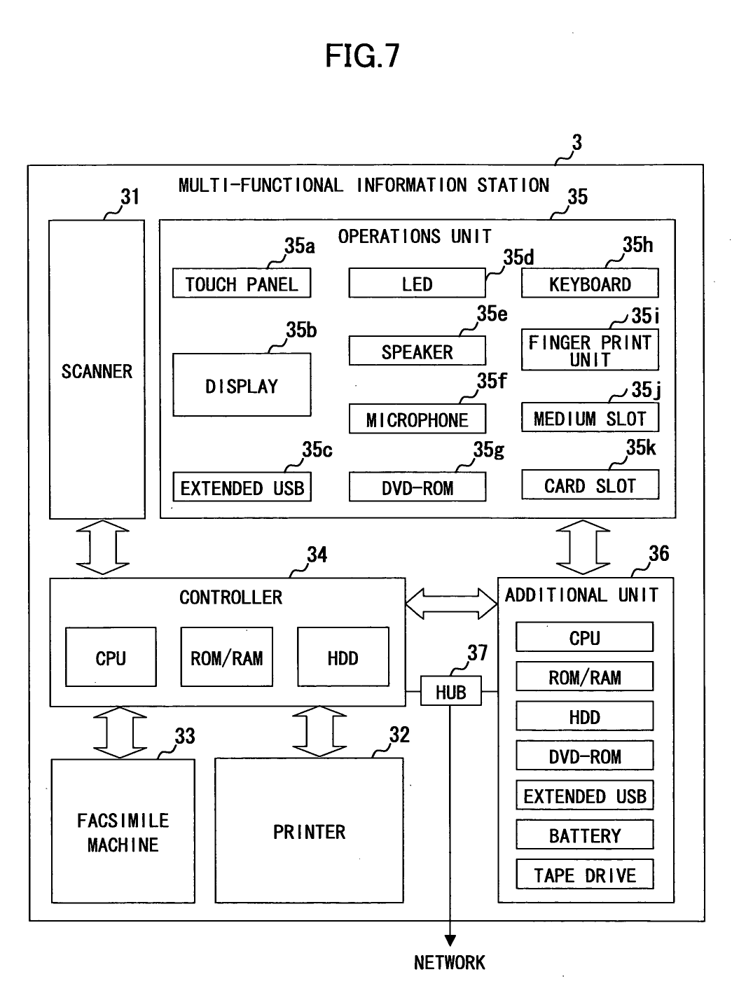

FIG. 7 is a hardware diagram showing a multifunctional information station 3 according to an embodiment. The multifunctional information station 3 is provided with the following: a scanner 31 for reading the image of document, a printer 32 for printing images on paper, a facsimile machine 33 for transmitting and receiving facsimile images, and a controller 34 for controlling the above elements. The controller 34 includes a CPU, ROM/RAM, and HDD. The multifunctional information station 3 can function as a copier by reading an image with the scanner 31 and printing the read image with the printer 32.

The multifunctional information station 3 is further provided with an operations unit 35, an additional unit 36, and a HUB 37. The operations unit 35 includes the following: a touch panel 35a, a display 35b, an extended USB 35c, an LED 35d for indicating state, a speaker 35e for outputting sound, a microphone 35f for inputting sound, a DVD-ROM drive 35g, a keyboard 35h, a fingerprint unit 35i for reading fingerprints, a media slot 35j for setting various memory media, and a card slot 35k for setting a user card. The additional unit 36 is further provided with the following: a CPU, ROM/RAM, a HDD, DVD-ROM drive, an extended USB, a battery for backup, and a tape drive for data backup. The HUB 37 connects the communication interfaces (NIC) (not shown) of the controller 34 and the additional unit 36, and further connects them to the network 2. Although in FIG. 7 the additional unit 36 is provided separately from the controller 34 that controls the scanning function, the printing function, the facsimile function, and the copying function, the additional unit 36 may be included in the controller 34 as a part.

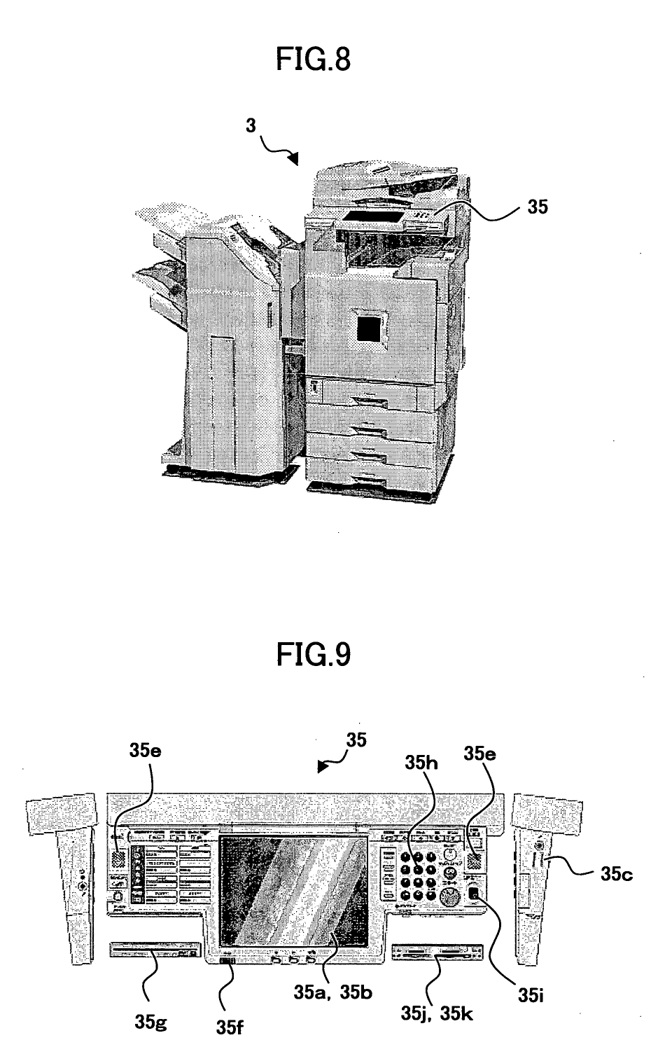

FIG. 8 is a perspective view showing the appearance of the multifunctional information station of FIG. 7. The operations unit 35 is disposed at the front side of the upper portion of the multifunctional information station 3.

FIG. 9 is a partial view showing the appearance of the operations unit 35 of the multifunctional information station 3. The touch panel 35a, the display 35b, the extended USB 35c, the speaker 35e, the microphone 35f, the DVD-ROM drive 35g, the keyboard 35h, the fingerprint unit 35i, the media slot 35j, and the card slot 35k are disposed as shown in FIG. 9.

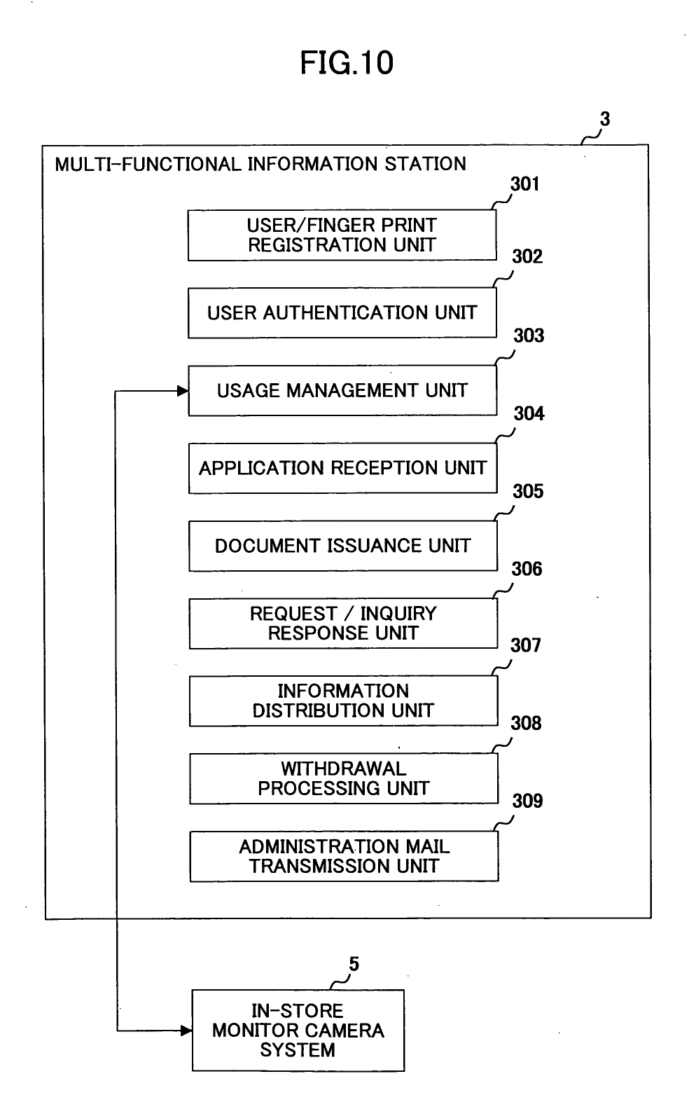

FIG. 10 is a block diagram showing the functions of the multifunctional information station 3. The multifunctional information station 3 includes the following functional blocks: a user/fingerprint registration unit 301 that registers user information and the fingerprint of the user in response to a user's operation; a user authentication unit 302 that authenticates a user when the user files an application, for example; and a usage management unit 303 that manages the use state of the multifunctional information station 3 based on images from a monitor camera provided in the convenience store and a use log. The multifunctional information station 3 further includes the following functional blocks: an application reception unit 304 that receives various applications in response to a user's operation; a document issuance unit 305 that issues documents using the printing function of the multifunctional information station 3; and a request/inquiry response unit 306 that responds to a request or an inquiry from the user. The multifunctional information station 3 yet further includes the following functional blocks: an information distribution unit 307 that distributes information from the local government or another information provider using the facsimile function, e-mailing function, and printing function, for example, of the multifunctional information station 3; a withdrawal processing unit 308 that processes the withdrawal of use fee from the bank account of the user; and an administrative mail transmission unit 309 that transmits an e-mail to the administrator of the information providing system indicating that the information has been distributed to the user.

The operation of the multifunctional information station 3 according to the above embodiment is described below.

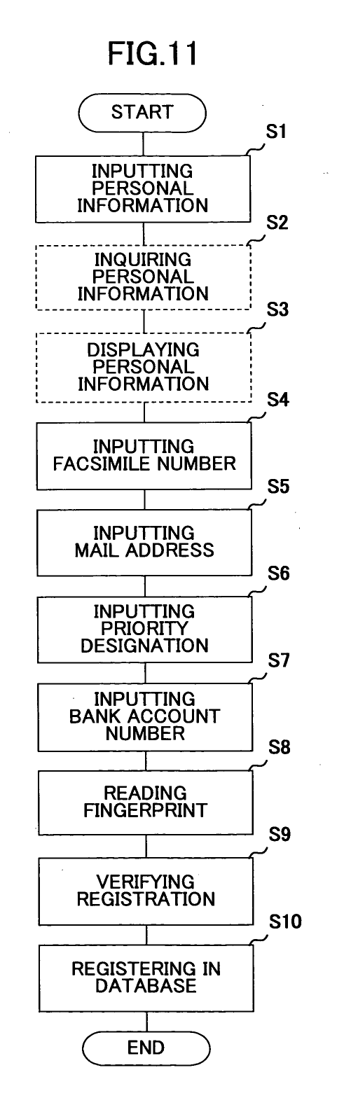

FIG. 11 is a flowchart showing the operation of a user/fingerprint registration according to an embodiment. Each user is required to register her user information and fingerprint before using the information providing system. A case in which a user registers her user information and fingerprint using the multifunctional information station 3 is described below. It is noted that the user can instead register her user information and fingerprint at the window of the local government, for example.

As shown in FIG. 11, the process starts with a step in which the user inputs her personal information through the operations unit 35 (FIGS. 7, 8, and 9) in response to a request from the user/fingerprint registration unit 301 (FIG. 10) of the multifunctional information station 3 and the user/fingerprint registration unit 11 (FIG. 2) of the center server 1 that is interlocked thereto at the beginning of the registration (step S1). If the information provider such as the local government already has the personal information of the user, the user may be required to input only a part of the personal information such as her “citizen code”. The multifunctional information station 3 may guide the user by displaying instructions on the display 35b or outputting the instructions through the speaker 35e as voice. The multifunctional information station 3 may accept input from the user through the keyboard 35h and buttons, or may accept voice input through the microphone 35f.

If a part of the personal information such as the “citizen code” is input, the user/fingerprint registration unit 301 of the multifunctional information station 3 queries the user/fingerprint registration unit 11 (FIGS. 1 and 2) (step S2). The multifunctional information station 3 displays the input “citizen code” and the other information (address, full name, phone number, for example) retrieved from the center server 1 (step S3). According to the above arrangement, the user can avoid any input error.

The user inputs facsimile number, e-mail address, the priority designation (whether the user wishes to have information distributed by facsimile, e-mail, or neither of the above), and bank account number (steps S4-S7). The user has her fingerprint read by the fingerprint unit 35i (FIGS. 7 and 9) (step S8).

The multifunctional information station 3 has the user verify the input information (step S9), and registers the user in the user information database 101 via the user/fingerprint registration unit 11 (FIG. 2) (step S10). Then, the process terminates.

Once the user/fingerprint registration of the user is completed, a user card is issued by the information provider such as the local government. The user card may be delivered to the user via post mail. If the multifunctional information station 3 is provided with a card issuance function, the user card can be issued by the multifunctional information station 3 in response to the registration or after a predetermined verification phase. If the local government has issued citizen cards, for example, the citizen cards may be used as the user cards.

After the completion of the user/fingerprint registration, the user can use the information providing system after verification based on the user card and fingerprint. According to the above arrangement, the security level of the information providing system is improved, but the user can use the information providing system with the user card and fingerprint more easily than an information providing system that requires a user ID and a password.

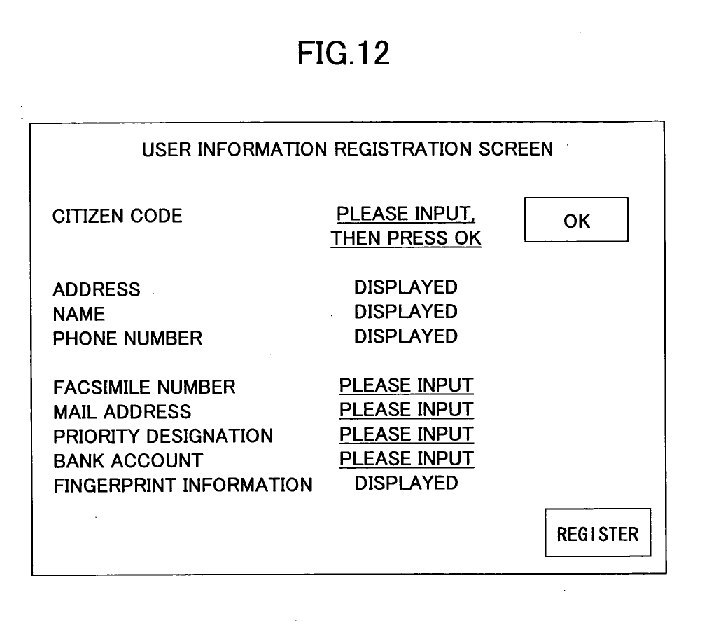

FIG. 12 is an exemplary screen for registering the user information, for example, according to an embodiment. If the user inputs her citizen code and presses “OK” button, her “address”, “full name”, and “phone number” are displayed. The user can register herself by inputting her “facsimile number”, “mail address”, “priority designation”, and “bank account (number)” and pressing the “register” button.

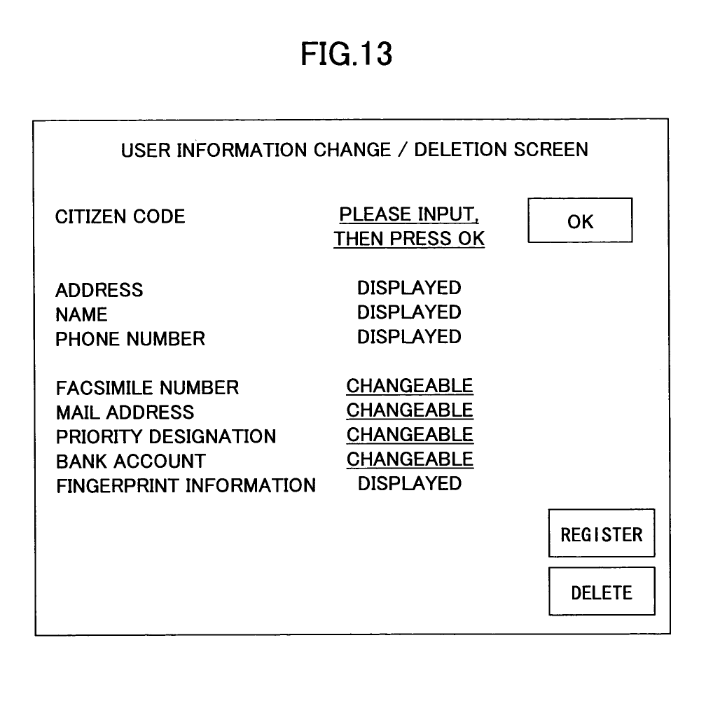

FIG. 13 is an exemplary screen for updating and deleting the user information, for example, according to an embodiment. Once the user is authenticated by reading her fingerprint, the user can update or delete her user information. If the user inputs her “citizen code” and then presses the “OK” button, her “address”, “full name”, and “phone number”, for example, are displayed. The user can overwrite the “facsimile number”, “mail address”, “priority designation”, and “bank account (number)” and press the “change” button in order to update them. The user can delete the user/fingerprint registration by pressing the “delete” button.

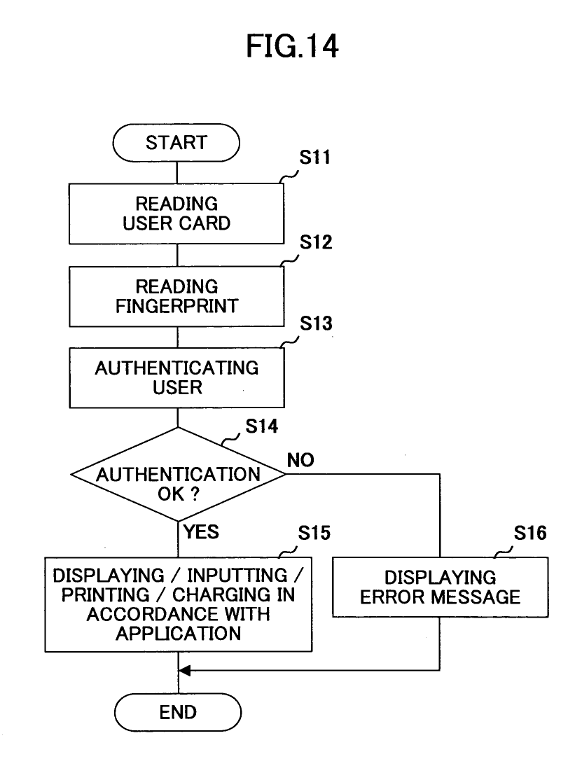

FIG. 14 is a flowchart for explaining processing of applications, requests, and inquiries according to an embodiment. As the local government does conventionally through the window, for example, the multifunctional information station 3 processes the filing of various applications, and responds to various requests and inquiries from the user. The user usually uses the multifunctional information station 3 disposed in a convenience store, for example, close to her house. However, the user may use any other multifunctional information station 3 regardless of the region in which it is disposed. The issuance of documents is similar in this regard. According to the above arrangement, the user can use the information providing system while she is out for shopping, for example. As a result, the information providing system can be made more convenient and useful.

In FIG. 14, the process is controlled by the application reception unit 304 and the request/inquiry response unit 306 of the multifunctional information station 3 (FIG. 10) and the application reception unit 14 and the request/inquiry response unit 16 (FIG. 2) of the center server 1 that are interlocked thereto. At the beginning of the process, the user card is read (step S11), and the user's fingerprint is read (step S12). The user authentication unit 302 requests the user authentication unit 12 (FIG. 2) to authenticate the user (step S13). The user authentication unit 12 of the center server 1 verifies the user card and the user's fingerprint with reference to registered data stored in the user information database 101. If the multifunctional information station 3 has duplicated the information database 10I (FIG. 2), the multifunctional information station 3 can authenticate the user by itself.

Next, if the authentication fails (No in step S14), an error message is displayed (step S16), and the process terminates.

If the user is authenticated (Yes in step S14), a suitable screen for the application, request, or inquiry is displayed, or the user is requested to input appropriate information depending on the application, request, or inquiry. As a result of the completion of the procedure, if a document needs to be issued, the document is printed by the printer (step S15). Subsequently, the multifunctional information system acquires the mail address of the administrator of the local government, for example, from the administrator information database 102, and transmits an administrative mail to the administrator. The administrative mail is typically addressed to the administrator of the local government, for example, and CC (carbon copy) or BCC (blind carbon copy) copies may be transmitted to other personnel whose e-mail addresses have been registered. The “subject” and “body” of the administrative mail can be automatically generated so that they indicate the user, issued document, provided information, the number of copies, and date, for example. If necessary, the “category” indicating that the e-mail is an administrative mail may be included so that the administrator who receives this e-mail can easily identify the mail. If the input information needs to be edited, the information processing function of the multifunctional information station 3 enables the user to edit the input information in the same manner as she uses word processor or graphics software.

A use fee may be charged to the user. The user can settle the use fee by inserting cash into a charge box (coin rack) provided to the multifunctional information station 3, or otherwise by having the use fee withdrawn from her bank account. The settlement may be made by a debit card. In the case of the withdrawal from the bank account (including settlement by a debit card), the withdrawal is recorded as data of the bank transmission database 103 (FIG. 5). Specifically, the user code, name, and bank account number of the user information database 101 (FIG. 3) are set as the user code, name, and bank account number of the bank transmission database 103. The amount to be paid is set as the amount of the bank transmission database 103, and the flag indicating data transmitted and the flag indicating withdrawal processed are set to “0” and are stored. The withdrawal from the bank account is processed in a withdrawal process to be described below. In the above filing of applications, for example, the multifunctional information station 3 can guide the user by displaying instructions on the display 35b of thee operations unit 35 (FIGS. 7 and 9) of the multifunctional information station 3, or by outputting voice instructions through the speaker 35e. The multifunctional information station 3 can accept input through the operation of the keyboard 35h and other buttons, or through the microphone 35f as voice input.

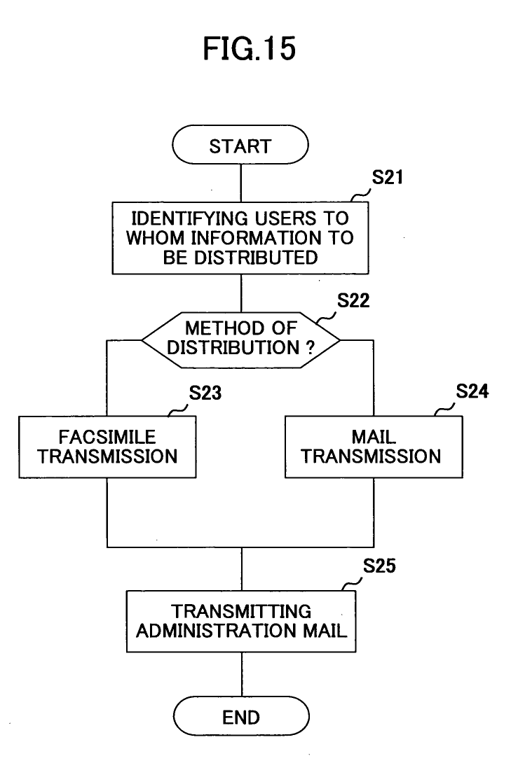

FIG. 15 is a flowchart for explaining the distribution of information according to an embodiment. The information provider such as the local government distributes information to the users The information distribution unit 17 of the center server 1 acquires information to be distributed from the information distribution database 105 (FIG. 2), and transmits the information to the multifunctional information station 3 of the region to which the information is required to be distributed. Different information may need to be distributed to different regions. Accordingly, particular information may be distributed to a region, but may not be distributed to another region.

In FIG. 15, the information distribution unit 307 (FIG. 10) of the multifunctional information station 3 controls the distribution of information. At the beginning, the users to whom information needs to be distributed are identified (step S21). The method of distribution is selected in accordance with the “priority designation” of the user information database 101 (step S22), and the information is transmitted via facsimile (step S23) or via e-mail (step S24).

The information distribution unit 307 (FIG. 10) acquires the mail address of the administrator of the local government, for example, and transmits an administrative mail (step S25). If the information is transmitted to the user via e-mail, the e-mail addressed to the user may be transmitted to the administrator as a CC. If the information is transmitted via facsimile, the administrative mail ay be addressed to the administrator of the local government, for example. If there are other personnel (registered as other addresses) who need to be notified, BCCs may be transmitted to them. The “subject” and “body” of the administrative mail can be automatically generated to indicate the user, distributed information, and date, for example. A “category” indicating that the mail is an administrative mail may be inserted, if necessary, in the mail, so that the administrator who receives the mail can easily manage the mail with a mailer program.

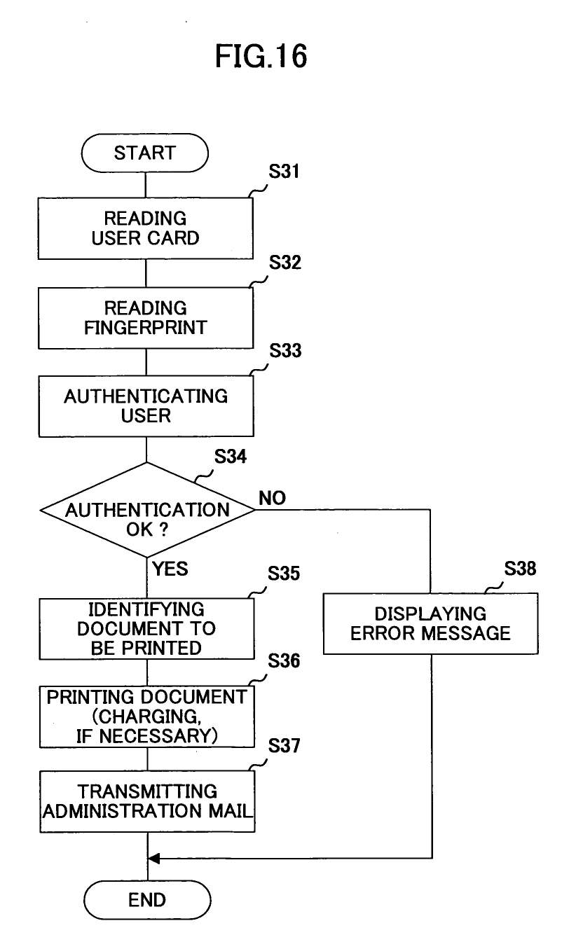

FIG. 16 is a flowchart for explaining the issuance of documents according to an embodiment. Documents may be issued in a case in which the user files an application as described above with reference to FIG. 14, or in a case in which particular information that is not suitable for facsimile or e-mail is distributed as printed material.

In FIG. 16, the document issuance unit 305 (FIG. 10) of the multifunctional information station 3 controls the issuing of documents. At the beginning, the user card is read (step S31), and the user's fingerprint is read (step S32). The user authentication unit 302 requests the user authentication unit 12 (FIG. 2) of the center server 1 to authenticate the user (step S33). The user authentication unit 12 of the center server 1 authenticates the user by verifying the user card and the user's fingerprint with registered data of the user information database 101. If a copy of the user information database 101 (FIG. 2) is provided in the multifunctional information station 3, the multifunctional station 3 can authenticate the user by itself.

Subsequently, if the authentication fails (No in step S34), an error message is displayed (step S38). The process then terminates.

If the user is successfully authenticated (Yes in step S34), a document to be printed is identified (step S35), and the document is printed (step S36). If the document is multiple-paged, the document can be bound by the multifunctional information station 3. The user can print multiple copies of the document, if necessary, using the multifunctional information station 3.

If a use fee becomes payable, the multifunctional information station 3 may charge the use fee to the user. The user can settle the use fee by inserting cash into a charge box (coin rack) provided to the multifunctional information station 3, or otherwise by having the use fee withdrawn from her bank account. In the case of the withdrawal from the bank account, the withdrawal is recorded as data of the bank transmission database 103. Specifically, the user code, name, and bank account number of the user information database 101 (FIG. 3) are set as the user code, name, and bank account number of the bank transmission database 103. The amount to be paid is set as the amount of the bank transmission database 103, and the flag indicating data transmitted and the flag indicating withdrawal processed are set to “0” and are stored. The withdrawal from the bank account is processed in a withdrawal process to be described below.

Subsequently, an administrative mail is transmitted to the mail address of the administrator of the local government, for example, acquired from the administrator information database 102 (step S37). The administrative mail is typically addressed to the administrator of the local government, for example, and BCCs may be transmitted to other personnel whose e-mail addresses have been registered. The “subject” and “body” of the administrative mail can be automatically generated so that they indicate the user, issued document, provided information, the number of copies, and date, for example. If necessary, the “category” indicating that the e-mail is an administrative mail may be included so that the administrator who received this e-mail can easily manage the mail using a mailer program.

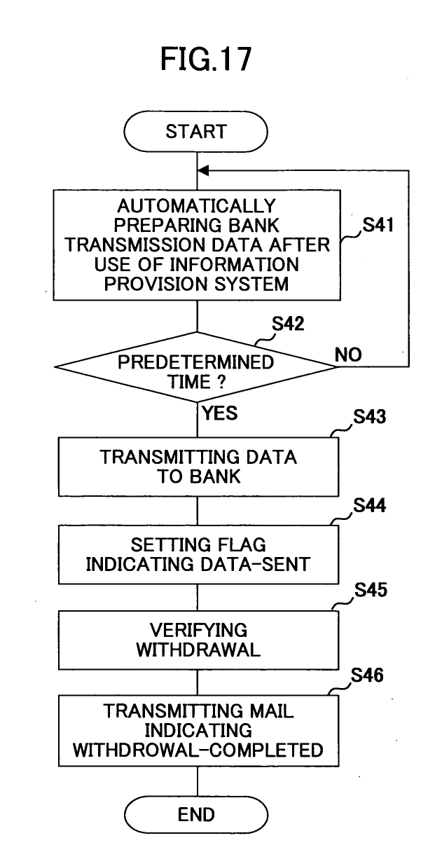

FIG. 17 is a flowchart for explaining withdrawal according to an embodiment.

In FIG. 17, the withdrawal processing unit 308 (FIG. 10) of the multifunctional information station 3 automatically generates bank transmission data after the user uses the information providing system (step S41).

When it comes to a predetermined time (Yes in step S42), the generated bank transmission data are transmitted to the bank (step S43). The generated bank transmission data are stored in the bank transmission database 103 (FIG. 2).

The “flag indicating data transmitted” of the bank transmission data is set (step S44) in order to avoid transmitting the same data more than once. Specifically, if the bank transmission data have been successfully sent, the flag is set to “1”.

Subsequently, a response from the bank is used to confirm that the withdrawal has been successfully processed by the bank (step S45). When the withdrawal is confirmed, the flag indicating withdrawal processed” of the bank transmission data is set to “1”.

Subsequently, a mail notifying the user and the administrator that the withdrawal has been completed is transmitted (step S46). The process then terminates.

An embodiment in which the withdrawal is processed by the multifunctional information station 3 is described above. However, the withdrawal may be processed in the center server 1.

In FIG. 10, the users who use the multifunctional information station 3 are continuously monitored by an in-store monitor camera system 5. The image output from the in-store monitor camera system 5 is fed to the multifunctional information station 3, and is stored with information indicating date and time of the use under the control of the usage management unit 303 and the usage management unit 13 of the center server 1 interlocked thereto. According to the above arrangement, even if a false use is found some days after the false use, the false user may be identifiable with reference to the date and time. The security level of the information providing system can be improved. As a result, the information providing system can be operated without operators.

The preferred embodiments of the present invention are described above. The present invention is not limited to these embodiments, but variations and modifications may be made without departing from the scope of the present invention. It is noted that the embodiments and the drawings should not be interrupted as limiting the present invention.

For example, the above embodiments are mainly based on the application of the present invention to the local government, but the present invention is not limited to these embodiments. The present invention can be applied to an information providing system for registered members of a department store, a shopping center, a rental video chain, and a fitness club, for example. It is apparent that the present invention is also applicable to an information providing system between the federal government and the state governments, between the state government and the local governments, among the local governments, between a firm and another firm or customers (product information, seminar information, and exhibition information, for example). It is also apparent that the present invention is applicable regardless the information providing service being charged for or free.

This patent application is based on Japanese Priority Patent Application No. 2003-326028 filed on Sep. 18, 2003, and No. 2004-247064 filed on Aug. 26, 2004, the entire contents of which are hereby incorporated by reference.

1. An information providing system, comprising:
a plurality of multifunctional information stations having at least printing, facsimile, and e-mailing functions; and
a center server connected to the multifunctional information stations via a network;
wherein
the center server receives applications, issues documents, and distributes information via the multifunctional information stations.

2. The information providing system as claimed in claim 1, further comprising:
a user authentication unit that authenticates a user by verifying a user card and a fingerprint of the user.

3. The information providing system as claimed in claim 1, further comprising:
a usage management unit that manages the use of the multifunctional information station to which the usage management unit is provided thereto based on an image from a monitor camera monitoring users who use the multifunctional information station and a use log.

4. The information providing system as claimed in claim 1, further comprising:
an administrative mail transmission unit that transmits an administrative mail to an administrator after a facsimile image or an e-mail message is sent or a document is printed.

5. The information providing system as claimed in claim 1, further comprising:
a withdrawal processing unit that has a use fee withdrawn from a bank account of a user, or collects the use fee using a coin rack.

6. The information providing system as claimed in claim 1, wherein
the multifunctional information station is provided with an interface for receiving voice instructions.

7. The information providing system as claimed in claim 1, further comprising:
an editing unit with which a user can edit a document.

8. A computer program that causes a computer to perform the steps of:
communicating with a multifunctional information station connected via a network;
receiving the filing of various applications from a plurality of the multifunctional information stations; and
issuing a document and distributing information to the multifunctional information stations.

9. A method of providing information, the method comprising the steps of:
receiving the filing of various applications from a plurality of multifunctional information stations having printing, facsimile, and e-mail functions;
issuing a document and distributing information through the multifunctional information stations.

10. The method as claimed in claim 9, further comprising the step of:
authenticating a user by verifying a user card and a fingerprint of the user.

11. The method as claimed in claim 9, further comprising the steps of:
monitoring users who use the multifunctional information stations; and
managing a use state of the multifunctional information based on a monitored image and a use log.

12. The method as claimed in claim 9, further comprising the step of:
transmitting an administrative mail to an administrator after the multifunctional information station transmits a facsimile image or an e-mail, or prints a document.

13. The method as claimed in claim 9, further comprising the step of:
withdrawing a use fee from a bank account of a user or collecting the use fee in cash using a coin rack.

14. The method as claimed in claim 9, wherein the multifunctional information station has an interface through which a user operates the multifunctional information station.

15. The method as claimed in claim 9, further comprising the step of:
editing an application to be filed.
